(19) United States
(12) Patent Application Publication
(10) Pub. No.: US 2015/0242819 A1
(43) Pub. Date: Aug. 27, 2015

(54) SYSTEMS AND METHODS FOR IMPROVING SCHEDULING INEFFICIENCIES USING PREDICTIVE MODELS

(71) Applicant: Smart Scheduling, LLC, Watertown, MA (US)

(72) Inventors: Christopher MOSES, Somerville, MA (US); Joel SUTHERLAND, Somerville, MA (US)

(21) Appl. No.: 14/697,970

(22) Filed: Apr. 28, 2015

Related U.S. Application Data
(63) Continuation of application No. PCT/US13/67783, filed on Oct. 31, 2013.
(60) Provisional application No. 61/720,446, filed on Oct. 31, 2012.

(51) Int. Cl. G06Q 10/10; G06N 5/04; G06N 7/00; G06N 99/00

(52) U.S. Cl. CPC G06Q 10/1095; G06N 99/005; G06N 5/04; G06N 7/00

(57) ABSTRACT

Systems and methods are presented for scheduling appointments efficiently by generating predictive models using historical appointment data and using these models to predict in advance whether an appointment will be a no-show or a cancellation. The predictive models may be based on logistic regression methods, support vector machines, or neural networks. If the model predicts that an appointment in a particular time-slot will probably be a no-show/cancellation, a scheduling system may decide to double-book that time-slot in order to reduce scheduling inefficiency.

### CROSS-REFERENCE TO RELATED APPLICATIONS

This application is a Continuation of International Application No. PCT/US2013/067783, entitled SYSTEMS AND METHODS FOR IMPROVING SCHEDULING INEFFICIENCIES USING PREDICTIVE MODELS, filed Oct. 31, 2013, which claims the benefit of priority to U.S. Provisional Application No. 61/720,446, entitled METHODS FOR SCHEDULING APPOINTMENTS FOR HEALTHCARE PROVIDERS, filed Oct. 31, 2012, the disclosures of which are hereby incorporated by reference in their entirety.

### BACKGROUND

1. Field of Embodiments

The present invention relates generally to scheduling and logistics and, more specifically, to systems and methods for improving patient scheduling inefficiencies.

2. Discussion of Related Art

Healthcare in the United States is delivered in a number of settings, including inpatient and outpatient settings. Most commonly, outpatient care is delivered at doctors' offices. Currently, there are more than 250,000 outpatient practices in the United States. Outpatient practices require scheduling procedures for scheduling patient visits in advance. Scheduling avoids overwhelming the capacity of a practice to see patients, helps to provide information to patients so that they can come at an appropriate time, and allows a practice to make the best use of resources that are only available at a particular time or place.

However, when a patient fails to keep an appointment for a particular time slot, or cancels an appointment without adequate advance notice, an outpatient practice may not be able to fill the time slot with another appointment. If such no-shows or late cancellations are frequent, it can lead to significant inefficiency and loss of revenue.

Due to the problem of failed appointments, practices have tried a variety of strategies to mitigate the revenue loss and wasted time of providers. These strategies include sending reminders to patients (automated or manual, by phone, text message, or email, or by mail), using different scheduling paradigms such as open access scheduling, and by employing a number of heuristics that may include patient or doctor-specific information.

Another strategy is to schedule more than one appointment per time slot—a practice known as “overbooking”—in order to increase the probability of a full schedule. Overbooking reduces the frequency of unfilled time slots, but excessive overbooking can lead to problems if, e.g., two patients are scheduled for the same time slot and both of them show up. If this happens too often, it can lead to long wait times, overfilled waiting rooms, reduced patient satisfaction, and suboptimal care. Simple strategies may be employed to reduce these occurrences, such as overbooking based on the mean historical cancellation rate, or overbooking only unconfirmed appointments. However, the effectiveness of these techniques is limited.

### SUMMARY OF EMBODIMENTS

The methods and systems described herein address the limitations of the scheduling techniques described above by using predictive models to predict in advance whether an appointment will be a no-show or cancellation. Using this information, a practice can determine which time slots should be overbooked on an appointment-by-appointment basis, thereby reducing the number of unfilled time slots while avoiding excessive overbooking.

In some embodiments, predictive models are generated using historical data relating to patient scheduling. Historical data may include information about past appointments (e.g., date, time, location, patient name, patient demographic information, doctor name, appointment length, appointment type, etc.) and, for each appointment, classification data indicating whether the patient showed up to the appointment, canceled in advance, or was a no-show.

Some embodiments may employ various types of predictive models, and various modeling techniques, including logistic regression, support vector machines (SVM), recursive partitioning, multivariate adaptive regression splines, multiple additive regression trees, random forests, boosting, nonlinear regression, and neural networks. Some embodiments may employ predictive models that output a binary value—e.g. a model that outputs 0 if an appointment will be kept, and 1 otherwise. Other embodiments may employ models that estimate the probability of a no-show or a cancellation. Other embodiments may employ models that categorize appointments into three or more classes by estimating the likelihood that the appointment falls into each class.

Some embodiments include methods for scheduling appointments comprising: receiving, from a database, historical data relating to past appointments; parsing, by a computer, said historical data to produce training data, wherein said training data represents each past appointment as a collection of appointment features, and wherein, for each past appointment, said training data includes classification information that indicates whether the past appointment was kept; generating a predictive model based on said training data; predicting, using said predictive model, that a future appointment will not be kept; and deciding, based on the prediction that the appointment-holder will not keep the future appointment, to transmit a message to the appointment-holder.

Some embodiments also include methods for scheduling appointments comprising: receiving, from a database, historical data relating to past appointments; parsing, by a computer, said historical data to produce training data, wherein said training data represents each past appointment as a collection of appointment features, and wherein, for each past appointment, said training data includes classification information that indicates whether the past appointment was kept; generating a predictive model based on said training data; predicting, using said predictive model, that a future appointment will not be kept; and deciding, based on the prediction that the future appointment will not be kept, to allow a second appointment to be scheduled at the same time as the future appointment.

Some embodiments also include systems for scheduling appointments comprising: a scheduling server in communication with a database, the scheduling server comprising a computer-readable memory with computer-executable instructions stored therein, wherein said computer-executable instructions comprise: logic for receiving, from the database, historical data relating to past appointments; logic for parsing, by a computer, said historical data to produce training data, wherein said training data represents each past appointment as a collection of appointment features, and wherein, for each past appointment, said training data includes classification information that indicates whether the past appointment was kept; logic for generating a predictive model based on said training data; logic for predicting, using said predictive model, that a future appointment will not be kept; and logic for deciding, based on the prediction that the future appointment will not be kept, to allow a second appointment to be scheduled at the same time as the future appointment.

Some embodiments also include systems for scheduling appointments comprising: a scheduling server in communication with a database, the scheduling server comprising a computer-readable memory with computer-executable instructions stored therein, wherein said computer-executable instructions comprise: logic for receiving, from the database, historical data relating to past appointments; logic for parsing, by a computer, said historical data to produce training data, wherein said training data represents each past appointment as a collection of appointment features, and wherein, for each past appointment, said training data includes classification information that indicates whether the past appointment was kept; logic for generating a predictive model based on said training data; logic for predicting, using said predictive model, that a future appointment will not be kept; and logic for deciding, based on the prediction that the appointment-holder will not keep the future appointment, to transmit a message to the appointment-holder.

Some embodiments also include indicating, via a graphical user interface, that a second appointment is allowed to be scheduled at the same time as a future appointment. Some embodiments also include scheduling a telephone call to an appointment-holder in advance of a future appointment.

### BRIEF DESCRIPTION OF THE DRAWINGS

For a more complete understanding of various embodiments, reference is now made to the following descriptions taken in connection with the accompanying drawings in which:

FIG. 1 is a block diagram showing the architecture of a scheduling system according to some embodiments.

FIG. 2 shows a training set comprising historical information relating to appointments and classification information, according to some embodiments.

FIG. 3 shows a plot of a logistic function used by logistic regression models, according to some embodiments.

FIG. 4 shows a graphical representation of a support vector machine, according to some embodiments.

FIG. 5 shows a user interface for displaying information relating to automated and manual reminder calls, according to some embodiments.

FIG. 6 shows a user interface for setting/adjusting parameters that govern the behavior of the scheduling system, according to some embodiments.

FIG. 7 shows a user interface that uses color-coding to indicate the probability of a no-show/cancellation, according to some embodiments.

FIG. 8 shows how an open slot is displayed on a graphical scheduling interface, according to some embodiments.

FIG. 9 shows a neural network according to some embodiments.

### DETAILED DESCRIPTION

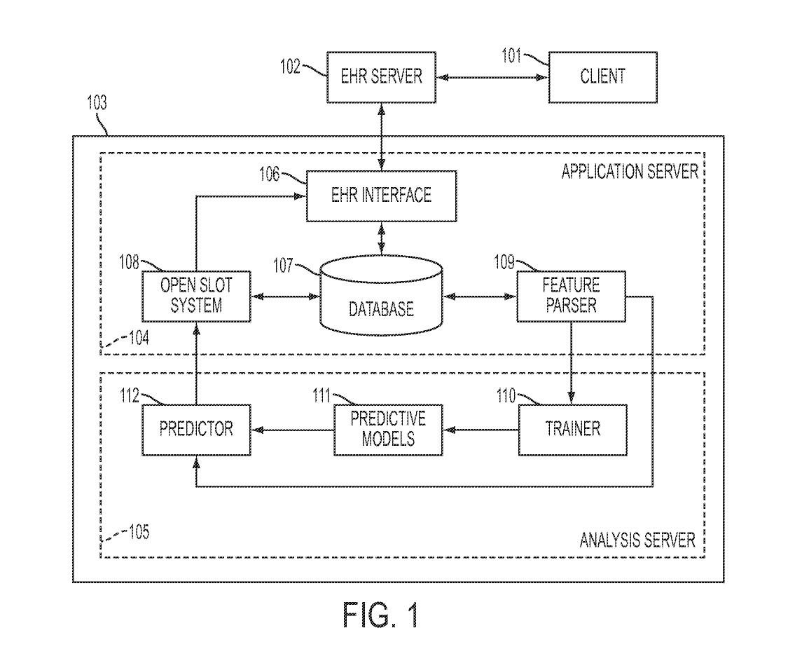

FIG. 1 is a block diagram showing a scheduling system according to one embodiment. Client software 101 provides a text-based or graphical scheduling interface to an end-user. The client software may run on any computing device having suitable input/display capabilities, including desktop computers and workstations, laptops, and mobile devices such as tablets and smartphones. The client interface may be a web-based interface provided via a web browser, or may run as a standalone application on the client machine. Client 101 communicates with EHR Server 102, which stores Electronic Health Record (EHR) information relating to past and/or future appointments, including demographic information (e.g. patient age, gender, etc.) administrative information (e.g. insurance type, insurance provider, number of recent hospital admissions, etc.) and clinical information relating to the patient's health and treatment (e.g., laboratory test results, patient biometrics, diagnoses, etc.). EHR Server 102 communicates with Scheduler 103, which generates predictive models based on historical data received from EHR Server 102, applies these models to future appointments to predict the likelihood of a cancellation or no-show, and uses these predictions to determine when to overbook appointments. The overbooking decisions made by Scheduler 103 are communicated back to EHR Server 102 and indicated to the end-user via Client 101. In some embodiments, Scheduler 103 comprises Application Server 104 and Analysis Server 105, which may run on separate computers or as separate processes on the same physical machine. Client 101, EHR Server 102, and Scheduler 103 may all be located on the same local-area or wide-area network, such as, e.g., the Internet. EHR Server 102 and/or Scheduler 103 may be unitary systems or systems distributed across a computer network, such as a cloud-computing network.

The embodiment shown in FIG. 1 operates in two phases: the training phase and the production phase. During the training phase, Scheduler 103 retrieves historical information from EHR Server 102 via EHR Interface 106. EHR Server 102 and EHR Interface 106 may communicate using one or more protocols/standards suitable for transferring information relating to appointments, patients, and/or other healthcare information (e.g. HL7), and may also communicate using ad-hoc protocols to transfer supplemental data and exchange procedure calls. In some embodiments, EHR Interface 106 includes a web-based interface (e.g., a RESTful Web Interface) that is designed to exchange information with EHR Server 102 via a published API. EHR Interface 106 may also instruct EHR Server 102—using the EHR Server's API—to create, update, or delete existing appointments. In some embodiments, EHR Interface 106 may use, e.g., a SQL interface to directly access database tables in EHR Server 102.

In the embodiment shown in FIG. 1, EHR Interface 106 stores the historical data downloaded from EHR Server 102 in Database 107. Before it is stored, the data may optionally be subjected to preprocessing. This preprocessing step may include an evaluation of the characteristics of the data, computation of summary statistics, and handling of missing data using standard statistical imputation methods.

After preprocessing, historical data relating to past appointments is sent to Feature Parser 109, which transforms it into a list of appointments called a training set, in which each appointment is represented as a collection of features. Predictive models are commonly used to calculate the percent likelihood that an event will occur based on its relationship to one or more independent variables, called features. In the context of appointments, features can include specific properties of an appointment, such as the appointment type (e.g., sick visit, well visit, etc.), appointment date, appointment time, and other appointment properties. Features may also be derived from data representing multiple appointments, e.g., the cancellation rate of specific visit types for a patient. Features may be continuous (e.g. patient age) or categorical (e.g., patient gender). Features may be selected using one or more feature selection methods known in the art, including but not limited to wrapper methods, filter methods, and embedded methods. Algorithms that may be used for feature selection include, but are not limited to, the LASSO algorithm, stepwise regression, and recursive feature elimination.

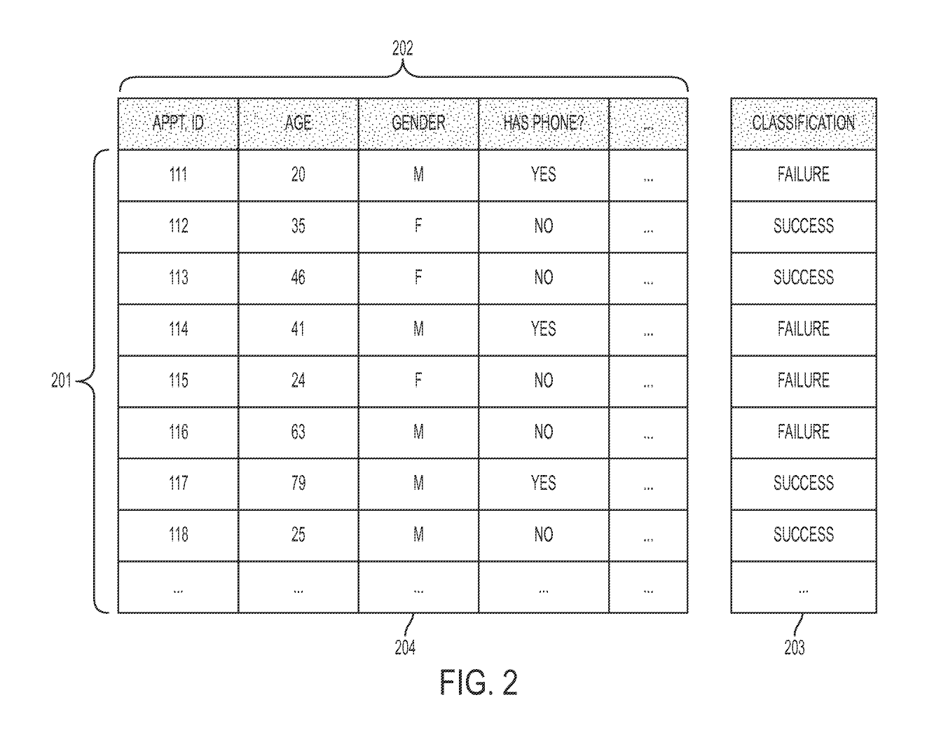

FIG. 2 shows a training set output by Feature Parser 109, according to one embodiment. The rows 201 of table 204 represent appointments and the columns 202 of table 204 represent individual features, such as, e.g., an appointment ID, the patient's age, the patient's gender, whether the patient has a phone, etc. Each appointment is also associated with a classification, shown in table 203, which indicates whether the appointment was a failure (i.e., a cancellation or no-show) or a success (i.e., the patient showed up). The classification of an appointment may be represented as a single bit—for example, 0 for failure and 1 for success. The features shown in FIG. 2 are exemplary, and are not intended to represent a comprehensive list of possible appointment features. The training sets output by Feature Parser 109 may be in any format suitable for representing the information shown in FIG. 2, such as comma separated value (CSV) format, XML, Microsoft Excel format, tab-delimited text, etc.

In the final stage of the training phase, Trainer 110 uses the training set provided by Feature Parser 109 to generate one or more predictive models 111 that can be used to predict future cancellations and no-shows. The predictive models 111 may employ various techniques, including logistic regression, support vector machines, recursive partitioning, multivariate adaptive regression splines, multiple additive regression trees, random forests, boosting, nonlinear regression, and neural networks. The output of Trainer 110 is a set of predictive models 111, which may be represented using e.g., matrices, mathematical functions, vectors, or other data structures, depending on the type of predictive models that are generated. The predictive models 111 may be stored on Analysis Server 105, or may be stored in Database 107 for later retrieval.

During the production phase, the predictive models generated during the training phase are used to predict whether future appointments will be cancellations or no-shows. Information relating to future appointments is retrieved from EHR Server 102 via EHR Interface 106. As described above, EHR Server 102 and EHR Interface 106 may communicate using one or more protocols/standards suitable for transferring information relating to appointments, patients, and/or other healthcare information. The future appointment data is then stored in Database 107 and optionally preprocessed. Feature Parser 109 retrieves the future appointment data from Database 107 and transforms it into a format similar to the format shown in FIG. 2, except that during the production phase, the output of Feature Parser 109 does not include classification information.

Predictor 112 then applies the predictive models 111 generated during the training phase to the output of Feature Parser 109. Using predictive models 111, Predictor 112 is able to predict whether a future appointment will be a cancellation or a no-show. Depending on the type of predictive model used, the prediction may take the form of a binary classification (e.g., 0 if an appointment is predicted to be a failure, or 1 if otherwise) or a probability estimate (e.g., a real number between 0 and 1 representing the probability that the appointment will be a failure). Other embodiments may employ models that categorize appointments into three or more classes by estimating the likelihood that the appointment falls into each class.

These predictions are sent to the Open Slot System (OSS) 108, which determines which appointments should be overbooked. When OSS 108 determines that an appointment should be overbooked it creates an “open slot” appointment overlaying the original appointment, indicating that the time slot should be treated as if it were an unfilled slot in the schedule.

If Predictor 112 predicts that an appointment will be a cancelation or no-show, OSS 108 may respond in a variety of ways, depending on the rules programmed into the Open Slot System. For example, OSS 108 may be programmed not to create a new open slot (i.e., not to overbook the appointment) unless the medical provider's schedule is already full. Additionally, OSS 108 may be programmed to create open slots only for particular appointment types, or for appointments that take place at particular times or days of the week. Additionally, OSS 108 may be programmed to wait to create new open slots until data is received from an automated or manual reminder call, as explained below. Additionally, OSS 108 may be programmed to create, e.g., new open slots only in the last 15 minutes of a 45-minute appointment. These rules are exemplary only: OSS 108 may be programmed to create, update, and delete open slots based on any rule or combination of programmable rules that can be evaluated by the Open Slot System. When OSS 108 decides to create, update, or delete an open slot, this information is communicated to EHR Server 102 via EHR Interface 106. The client interface provided by Client 101 displays these open slots to the end-user, indicating that a new appointment may be scheduled during that time.

Some embodiments may generate and apply various types of predictive models for use in scheduling. In general, a predictive model is a method for predicting whether an event will occur based on its relationship to one or more independent variables. Some embodiments may employ predictive models that use various techniques, including but not limited to support vector machines, logistic regression, recursive partitioning, multivariate adaptive regression splines, multiple additive regression trees, random forests, boosting, nonlinear regression, neural networks. Further, some embodiments may use a combination of one or more known techniques, including the techniques listed above.

In the scheduling systems described herein, predictive models may be used to predict whether a patient will show up for a future appointment based on one or more features of the future appointment. As described above, these predictive models are generated using historical data relating to past appointments and other patient-related data, where each past appointment includes a classification indicating whether it was a success or failure.

A predictive model that employs logistic regression, according to some embodiments, may be represented as a mathematical function:

$${h}_{θ} ( x ) = \frac{1}{1 + {e}^{- ( θ \cdot x )}} \qquad ( 1 )$$

In equation (1), above, x is a vector of feature values [x₁, . . . , xₙ] corresponding to an appointment (represented in FIG. 2 as a row 201 of table 204) where each xᵢ is the value of a particular feature. The parameter θ is a vector of weights [θ₁, . . . , θₙ], that are computed during the training phase. Based on the vector dot product of x and θ, the function shown above computes h_{θ}(x): the probability that the given appointment will be a cancellation or a no-show.

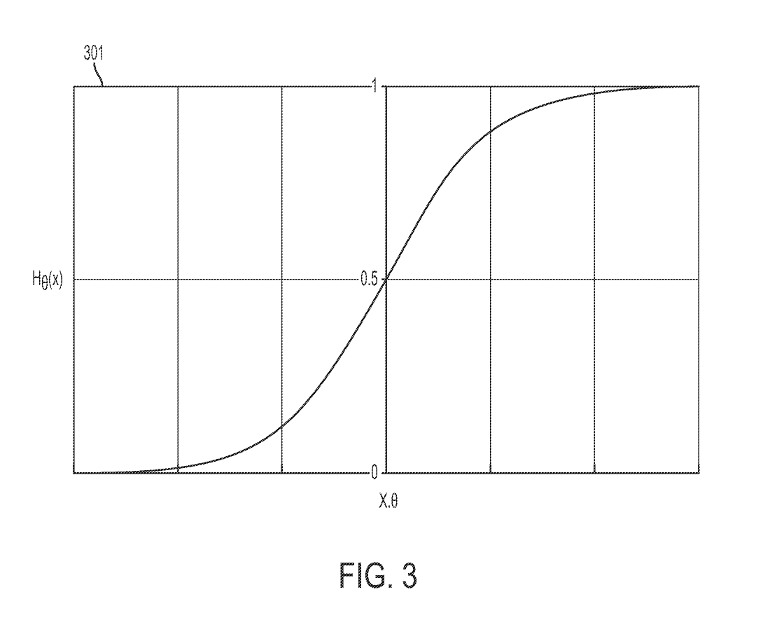

FIG. 3. shows a 2-dimensional plot of equation (1). The x-axis of plot 301 represents the value of the dot product of feature-vector x and weights vector θ. The y-axis of plot 301 represents h_{θ}(x), a number between 0 and 1 that indicates the probability that an appointment having feature x will be a cancellation or a no-show.

In the above example, the weights vector θ is computed during the training phase based on historical appointment data and associated classification information (e.g., classification information 203). These weights may be computed using one or more standard techniques that are known in the art, including, but not limited to Newton's Method, iteratively reweighted least squares (IRLS), the Broyden-Fletcher-Goldfarb-Shanno algorithm (BFGS), or equivalents. In some embodiments, logistic regression models are evaluated and tuned according to standard techniques, including, but not limited to the likelihood ratio test, the Wald statistic, or equivalents.

According to some embodiments, a predictive model may be a support vector machine (SVM). SVMs are algorithms that analyze patterns in data, and are used for classification and regression analysis. For a given appointment represented by a vector x of feature values, an SVM predicts whether the appointment will be a success or failure by determining the position of x relative to a hyperplane H. The location of the hyperplane H is ideally chosen such that appointments that are likely to result in a cancellation or no-show are located on one side of H, and all other appointments are located on the other side of H. The location of H is chosen during the training phase, which uses historical appointment data and classification information to calculate the maximum-margin plane separating the class of no-shows/cancellations from the class of successful appointments. This calculation may be performed using one or more standard methods known in the art for calculating or approximating optimal hyperplanes, including but not limited to Platt's Sequential Minimal Optimization (SMO) algorithm, and iterative methods designed to satisfy the Karush-Kuhn-Tucker (KKT) conditions.

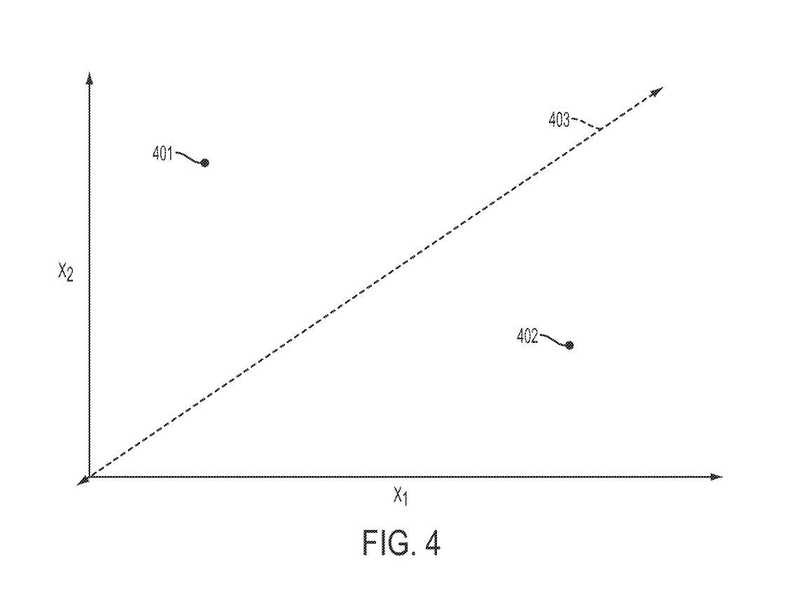

FIG. 4 shows a graphical representation of an SVM, according to some embodiments. Each point on the plane corresponds to an appointment having a 2-dimensional feature vector [x₁, x₂]. The hyperplane H is represented by dotted vector 403. The SVM in this example would classify appointment 401 as a likely no-show/cancellation because it is located to the upper left of hyperplane 403. The SVM would predict that appointment 402 will be a success, because it is located on the other side of hyperplane 403.

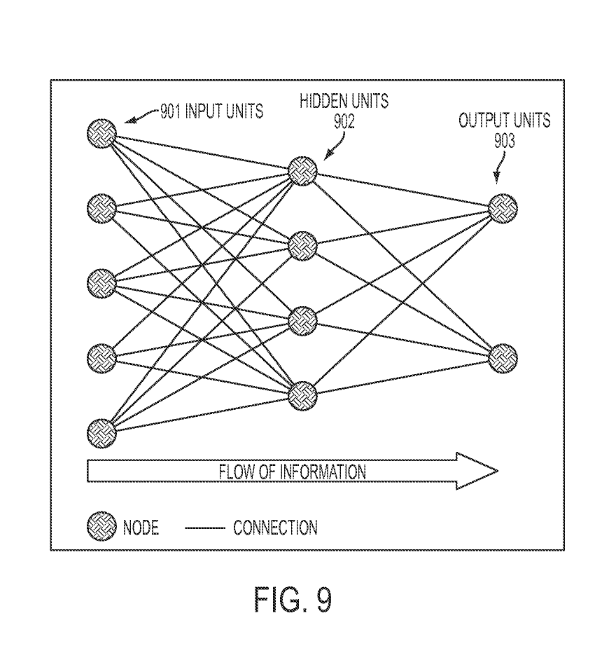

According to some embodiments, a predictive model may be implemented using a neural network. FIG. 9 shows a schematic of a neural network comprising input units 901, hidden units 902, and output units 903. Each input unit 901 corresponds to an appointment feature, and each output unit 903 represents an output classification. Types of nodes that may be employed in a predictive model based on a neural network include hyperbolic tangent nodes, sigmoid function nodes, and linear activation nodes. The neural network may be trained/tuned according to methods known in the art, including K-fold cross validation, the excluded rows method, comparison of the training and validation r-squared, use of boosting, outlier resistant modeling, transformation of variables, and penalty functions.

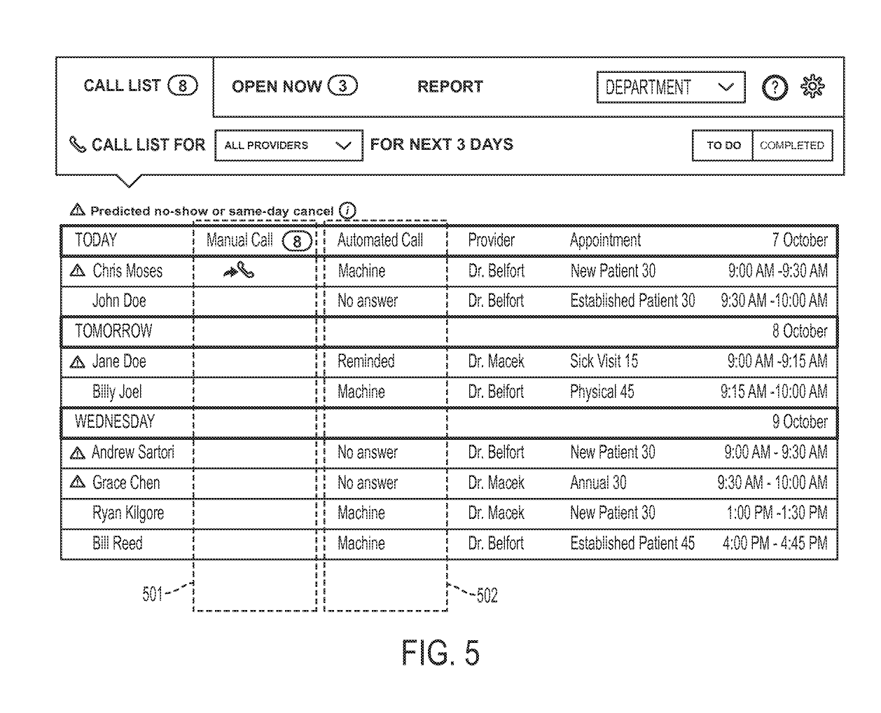

FIG. 5 shows a user interface that may be used by medical secretaries, nurses, and other healthcare personnel to target human resources to make reminder calls to patients, according to some embodiments. EHR Server 102 may include a telephone interface capable of making automated reminder calls; for example, EHR Server 102 may be configured to automatically call a patient two days in advance of the patient's appointment. The patient may respond to an automated reminder call in various ways: the patient may confirm attendance, cancel the appointment, request that the appointment be rescheduled, or the patient may accept the call but decline to provide a response. Alternatively, the call may go to voicemail, in which case a recorded reminder message will be left for the patient, or the call may receive no response at all. The result of the automated reminder call (e.g., “confirm,” “cancel,” “reschedule,” “no response provided,” “went to voicemail,” “number not in service”) is recorded by EHR Server 102 and displayed to the end-user via the interface shown in FIG. 5 (column 502).

Some embodiments may also schedule manual reminder calls to be made by the staff if a patient is predicted to cancel or no-show. Column 501 indicates appointments for which manual calls have been made. In some embodiments, EHR Server 102 may prioritize manual reminder calls based on the estimated likelihood of a cancellation/no-show. Alternatively, manual calls may be prioritized based on a combination of the likelihood of a cancellation/no-show and the urgency of the patient's condition (e.g., if a patient with a serious medical condition is not expected to keep an appointment, EHR Server 102 may schedule a high-priority reminder call for the patient). Automated reminder calls may also be prioritized based on the estimated likelihood that patients will fail to keep their appointments. In circumstances where only a limited number of automated and/or manual reminder calls can be made, prioritizing these calls based on the estimated likelihood of a cancellation/no-show allows a practice to target the appointments for which reminder calls will be most helpful.

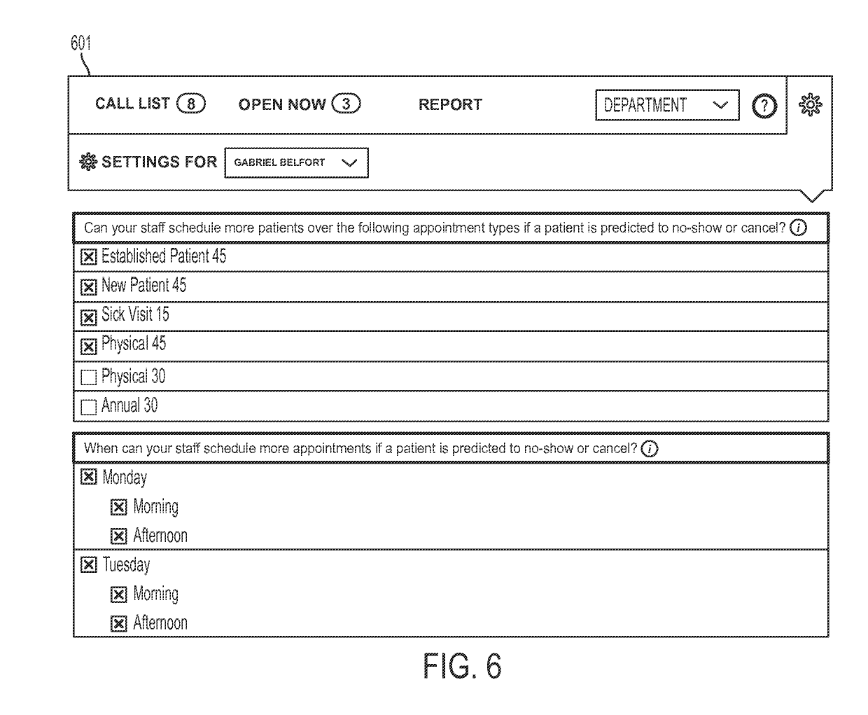

FIG. 6 shows a user interface 601, according to some embodiments, that can be used to set/adjust parameters that govern the behavior of OSS 108. Individual provider preferences can be updated by selecting or de-selecting checkboxes to control how the Open Slot System creates, updates, or deletes open appointments. Due to the fact that all patients have a greater-than-zero probability of showing up, there is a nonzero probability more than one patient will arrive for the same time slot, even if overbooking is done using an optimal predictive model. Because different providers have different tolerances for an excess number of patients, a slider or other user interface control can be used to indicate a provider's level of comfort with seeing excess patients. The slider can use mathematical confidence intervals to adjust the predictive model settings to change the Open Slot System, color-coding, or display of icons.

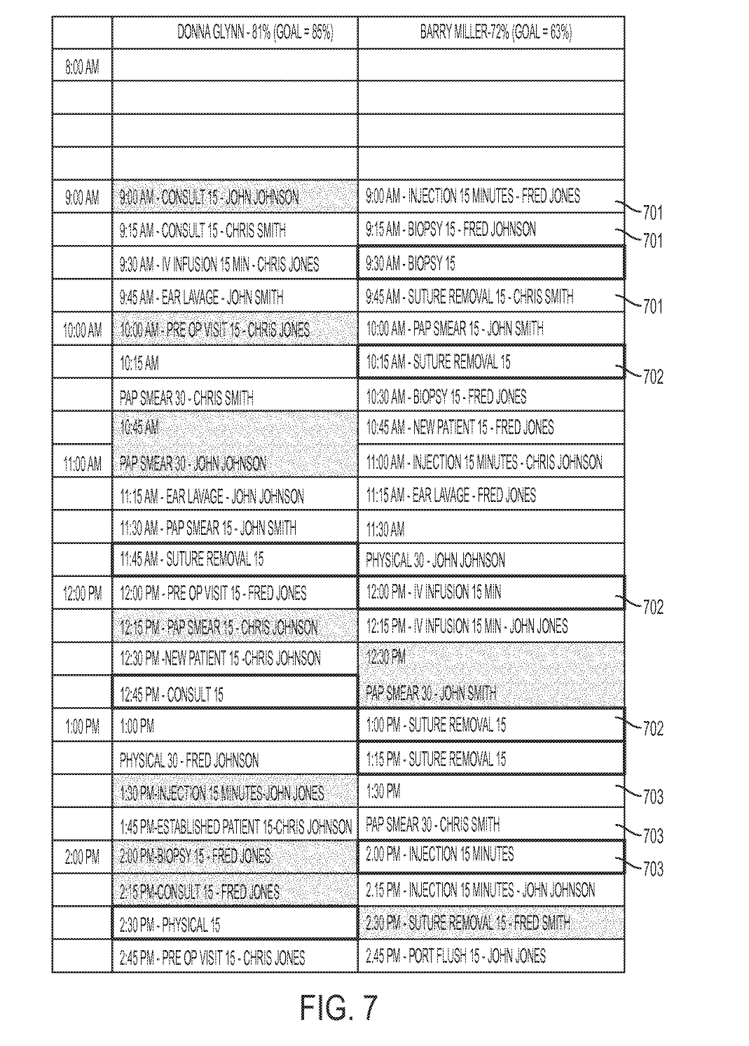

FIG. 7 shows a scheduling interface according to some embodiments. The interface shown in FIG. 7 uses color-coding to indicate the probability of a patient failing to make an appointment: appointments 701, predicted to be cancellations or no-shows, have a yellow background color; appointments 702, representing open slots, have a green background color; and appointments 703, for which patients are predicted to arrive on time, have a gray background color.

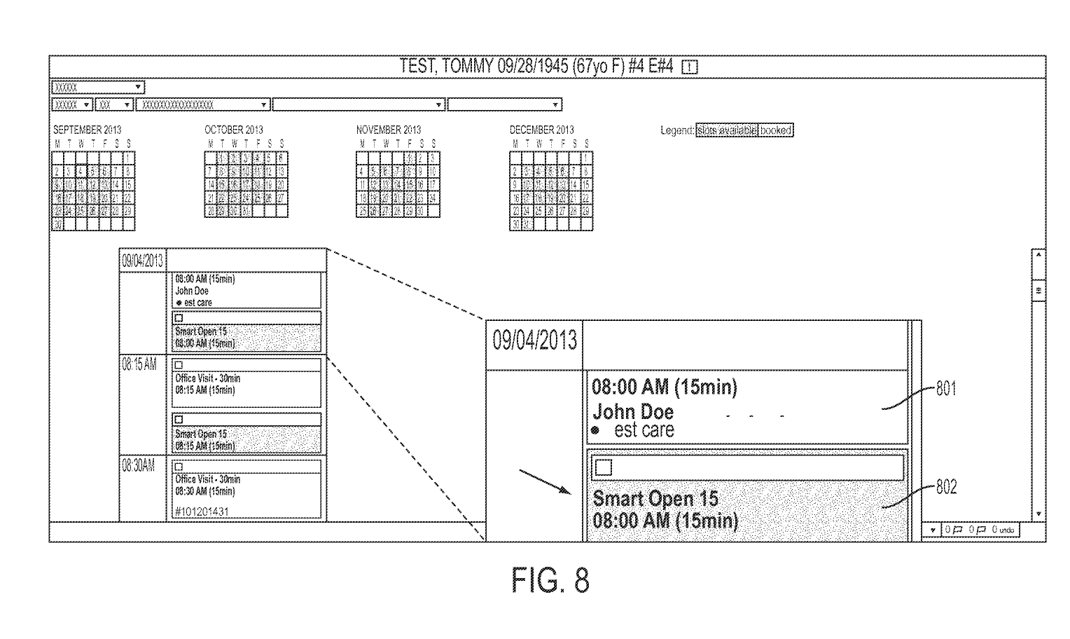

FIG. 8 shows another example scheduling interface, according to some embodiments. In FIG. 8, John Doe has an appointment 801 scheduled for 8:00 AM. The scheduling system has predicted that John Doe will cancel or no-show, so it has created an open slot (“Smart Open 15” 802) for the same time and duration as appointment 801. Medical secretaries and other scheduling staff can use this open slot as they would use any other unfilled slot in the schedule.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal for execution by, or for controlling the operation of, a data processing apparatus (e.g., a programmable processor, a computer, or multiple computers). A computer program (also known as a program, a software application, software, or code) can be written in any form of programming language, including compiled and interpreted languages, and can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and the subject matter described herein can be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical, or optical disks. Information carriers suitable for embodying computer program instructions and data include all forms of nonvolatile memory, including by way of example semiconductor memory devices, (e.g., EPROM, EEPROM, and flash memory devices), magnetic disks (e.g., internal hard disks or removable disks), magneto-optical disks, and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a cathode ray tube (CRT) or liquid crystal display (LCD) monitor, for displaying information to the user and a keyboard and a pointing device (e.g., a mouse or a trackball), by which the user can provide input to the computer. Other kinds of devices can be used to provide for interaction with a user as well. For example, feedback provided to the user can be any form of sensory feedback (e.g., visual feedback, auditory feedback, or tactile feedback) and input from the user can be received in any form, including acoustic, speech, or tactile input.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected using any form or medium of digital data communication, e.g., a communication network. Examples of communication networks include local-area networks (LANs) and wide-area networks (WANs), such as, e.g., the Internet.

Those skilled in the art will appreciate that the conception upon which this disclosure is based may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

It will be appreciated that the scope of the present invention is not limited to the above-described embodiments, but rather is defined by the appended claims. Further, it is to be understood that embodiments is not limited to the details of construction and to the arrangements of components set forth in the above description or illustrated in the drawings. Those skilled in the art will appreciate that, although the disclosed subject matter has been described and illustrated in the foregoing exemplary embodiments, these embodiments are described only by way of example. For example, while the foregoing embodiments involve the specific case of outpatient scheduling, the principles discussed above may be applied to any situation in which efficient scheduling is desired. Also, the phraseology and terminology employed in the foregoing description are descriptive only and should not be regarded as limiting.

What is claimed is:

1. A computer-implemented method for scheduling appointments comprising:
a. receiving, from a database, historical data relating to past appointments;
b. parsing, by a computer, said historical data to produce training data, wherein said training data represents each past appointment as a collection of appointment features, and wherein, for each past appointment, said training data includes classification information that indicates whether the past appointment was kept;
c. generating a predictive model based on said training data;
d. predicting, using said predictive model, that a future appointment will not be kept; and
e. deciding, based on the prediction that the future appointment will not be kept, to allow a second appointment to be scheduled at the same time as the future appointment.

2. The method of claim 1, wherein said predictive model comprises a logistic regression model, and wherein generating said predictive model comprises:
a. calculating, using a computer, the parameters of a logistic function; and
b. storing said parameters on a computer-readable medium.

3. The method of claim 1, wherein said predictive model comprises a support vector machine, and wherein generating said predictive model comprises:
a. calculating, using a computer, a set of parameters that defines a hyperplane; and
b. storing said parameters on a computer-readable medium.

4. The method of claim 1, wherein said predictive model comprises a neural network.

5. The method of claim 1, wherein, for each past appointment that was not kept, said classification information indicates whether the past appointment was cancelled, the method further comprising: predicting, using said predictive model, whether the future appointment will be cancelled.

6. The method of claim 1, further comprising indicating, via a graphical user interface, that a second appointment is allowed to be scheduled at the same time as the future appointment.

7. The method of claim 1, further comprising estimating the likelihood, using said predictive model, that said future appointment will not be kept.

8. A computer-implemented method for scheduling appointments comprising:
a. receiving, from a database, historical data relating to past appointments;
b. parsing, by a computer, said historical data to produce training data, wherein said training data represents each past appointment as a collection of appointment features, and wherein, for each past appointment, said training data includes classification information that indicates whether the past appointment was kept;
c. generating a predictive model based on said training data;
d. predicting, using said predictive model, that an appointment-holder will not keep a future appointment; and
e. deciding, based on the prediction that the appointment-holder will not keep the future appointment, to transmit a message to the appointment-holder.

9. The method of claim 8, wherein said predictive model comprises a logistic regression model, and wherein generating said predictive model comprises:
a. calculating, using a computer, the parameters of a logistic function; and
b. storing said parameters on a computer-readable medium.

10. The method of claim 8, wherein said predictive model comprises a support vector machine, and wherein generating said predictive model comprises:
a. calculating, using a computer, a set of parameters that defines a hyperplane; and
b. storing said parameters on a computer-readable medium.

11. The method of claim 8, wherein said predictive model comprises a neural network.

12. The method of claim 8, wherein, for each past appointment that was not kept, said classification information indicates whether the past appointment was cancelled, and wherein the method further comprises: predicting, using said predictive model, whether the appointment-holder will cancel the future appointment.

13. The method of claim 8, further comprising: scheduling a telephone call to the appointment-holder in advance of the future appointment.

14. A system for scheduling appointments comprising: a scheduling server in communication with a database, the scheduling server comprising a computer-readable memory with computer-executable instructions stored therein, wherein said computer-executable instructions comprise:
a. logic for receiving, from the database, historical data relating to past appointments;
b. logic for parsing, by a computer, said historical data to produce training data, wherein said training data represents each past appointment as a collection of appointment features, and wherein, for each past appointment, said training data includes classification information that indicates whether the past appointment was kept;
c. logic for generating a predictive model based on said training data;
d. logic for predicting, using said predictive model, that a future appointment will not be kept; and
e. logic for deciding, based on the prediction that the future appointment will not be kept, to allow a second appointment to be scheduled at the same time as the future appointment.

15. The system of claim 14, wherein said predictive model comprises a logistic regression model, and wherein the logic for generating said predictive model comprises:
a. logic for calculating, using a computer, the parameters of a logistic function; and
b. logic for storing said parameters on a computer-readable medium.

16. The system of claim 14, wherein said predictive model comprises a support vector machine, and wherein the logic for generating said predictive model comprises:
a. logic for calculating, using a computer, a set of parameters that defines a hyperplane; and
b. logic for storing said parameters on a computer-readable medium.

17. The system of claim 14, wherein said predictive model comprises a neural network.

18. The system of claim 14, wherein, for each past appointment that was not kept, said classification information indicates whether the past appointment was cancelled, and wherein the computer-executable instructions further comprise: logic for predicting, using said predictive model, whether the future appointment will be cancelled.

19. The system of claim 14, wherein the computer-executable instructions further comprise: logic for indicating, via a graphical user interface, that a second appointment is allowed to be scheduled at the same time as the future appointment.

20. The system of claim 14, wherein the computer-executable instructions further comprise: logic for estimating the likelihood, using said predictive model, that said future appointment will not be kept.

21. A system for scheduling appointments comprising: a scheduling server in communication with a database, the scheduling server comprising a computer-readable memory with computer-executable instructions stored therein, wherein said computer-executable instructions comprise:
a. logic for receiving, from the database, historical data relating to past appointments;
b. logic for parsing, by a computer, said historical data to produce training data, wherein said training data represents each past appointment as a collection of appointment features, and wherein, for each past appointment, said training data includes classification information that indicates whether the past appointment was kept;
c. logic for generating a predictive model based on said training data;
d. logic for predicting, using said predictive model, that a future appointment will not be kept; and
e. logic for deciding, based on the prediction that the appointment-holder will not keep the future appointment, to transmit a message to the appointment-holder.

22. The system of claim 21, wherein said predictive model comprises a logistic regression model, and wherein the logic for generating said predictive model comprises:
a. logic for calculating, using a computer, the parameters of a logistic function; and
b. logic for storing said parameters on a computer-readable medium.

23. The system of claim 21, wherein said predictive model comprises a support vector machine, and wherein the logic for generating said predictive model comprises:
a. logic for calculating, using a computer, a set of parameters that defines a hyperplane; and
b. logic for storing said parameters on a computer-readable medium.

24. The system of claim 21, wherein said predictive model comprises a neural network.

25. The system of claim 21, wherein, for each past appointment that was not kept, said classification information indicates whether the past appointment was cancelled, and wherein the computer-executable instructions further comprise: logic for predicting, using said predictive model, whether the appointment-holder will cancel the future appointment.

26. The system of claim 21, wherein the computer-executable instructions further comprise: logic for scheduling a telephone call to the appointment-holder in advance of the future appointment.
